(19) United States
(12) Patent Application Publication
(10) Pub. No.: US 2012/0078878 A1
(43) Pub. Date: Mar. 29, 2012

(54) OPTIMIZED LAZY QUERY OPERATORS

(75) Inventors: Bart De Smet, Bellevue, WA (US); Henricus Johannes Maria Meijer, Mercer Island, WA (US); Jeffrey Van Gogh, Redmond, WA (US); John Wesley Dyer, Monroe, WA (US)

(73) Assignee: MICROSOFT CORPORATION, Redmond, WA (US)

(21) Appl. No.: 12/891,951

(22) Filed: Sep. 28, 2010

(51) Int. Cl. G06F 17/30

(52) U.S. Cl. 707/713; 707/769; 707/737; 707/E17.017

(57) ABSTRACT

Query operators such as those that perform grouping functionality can be implemented to execute lazily rather than eagerly. For instance, one or more groups can be created and/or populated lazily with one or more elements from a source sequence in response to a request for a group or element of a group. Furthermore, lazy execution can be optimized as a function of context surrounding a query, among other things.

### BACKGROUND

Data processing is a fundamental part of computer programming. One can choose from amongst a variety of programming languages with which to author programs. The selected language for a particular application may depend on the application context, a developer's preference, or a company policy, among other factors. Regardless of the selected language, a developer will ultimately have to deal with data, namely querying and updating data.

A technology called language-integrated queries (LINQ) was developed to facilitate data interaction from within programming languages. LINQ provides a convenient and declarative shorthand query syntax to enable specification of queries within a programming language (e.g., C#®, Visual Basic® . . . ). More specifically, query operators are provided that map to lower-level language constructs or primitives such as methods and lambda expressions. Query operators are provided for various families of operations (e.g., filtering, projection, joining, grouping, ordering . . . ), and can include but are not limited to “where” and “select” operators that map to methods that implement the operators that these names represent. By way of example, a user can specify a query in a form such as “from n in numbers where n<10 select n,” wherein “numbers” is a data source and the query returns integers from the data source that are less than ten. Further, query operators can be combined in various ways to generate queries of arbitrary complexity.

As in SQL (Structured Query Language), LINQ utilizes a “GroupBy” operator/method to group elements. More specifically, “GroupBy” segments elements into groups that share a common attribute or key. For example, a sequence of numbers can be segmented into a group of odd numbers and a group of even numbers (e.g., key=“x % 2”). What is ultimately returned as the result of a “GroupBy” operation is a sequence of one or more groups, wherein each group includes one or more elements. Such grouping functionality is implemented by iterating through an input sequence from beginning to end, forming groups or buckets as function of a specified key and the input sequence, and adding elements into to appropriate groups based on their key. Subsequently, all or part of the grouped data can be utilized, for example, by an application to provide some useful functionality.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to efficiently implementing query operators. More specifically, query operators, such as but not limited to those providing grouping functionality, can be implemented to execute lazily, or on-demand, rather than eagerly as is conventionally done. By way of example and not limitation, one or more groups can be created and/or populated lazily with one or more elements from a source sequence in response to a request for a group or element of a group. Furthermore, a lazy operator implementation can be optimized based on context surrounding a query. For example, creation and population of groups can be restricted, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a group processor system.

FIG. 2 illustrates an employment of the group processor system in an exemplary scenario.

FIG. 3 is a block diagram of an optimized group processor system.

FIG. 4 is an exemplary marble diagram illustrating group operations.

FIG. 5 is a state machine diagram capturing employment data types to aid optimization.

FIG. 6 illustrates an exemplary operation that buffers elements acquired from a source stream at regular specified time intervals.

FIG. 7 is a flow chart diagram of a method of lazy grouping.

FIG. 8 is a flow chart diagram of a method of lazy group creation.

FIG. 9 is a flow chart diagram of a method of lazily populating a group.

FIG. 10 is a flow chart diagram of a method of optimizing lazy query operator execution.

FIG. 11 is a flow chart diagram of a method of optimizing lazy query operator execution with data types.

FIG. 12 is a flow chart diagram of method of optimizing lazy group creation.

FIG. 13 is a flow chart diagram of a method of optimizing lazy group population.

FIG. 14 is a schematic block diagram illustrating a suitable operating environment for aspects of the subject disclosure.

### DETAILED DESCRIPTION

Details below are generally directed toward lazy query operators and optimizations thereof. Conventionally query operators such as “GroupBy” among others are implemented too eagerly. More specifically, an input sequence is drained to create groups to which elements belong, even if only partial results are to be consumed. This leads to excessive computation and possibly non-termination in the case of infinite sequences, since the whole sequence needs to be scanned before groups are formed. By implementing such operators lazily, computation is more efficient, and a portion of a sequence can be consumed rather than requiring consumption of an entire sequence. Furthermore, lazy implementation can be optimized as a function of context. For example, constraints can be placed on group creation and/or population, among other things.

To illustrate a side effect of eager computation more concretely, consider the following piece of code that prints all elements that are being pulled from the sequence, wherein the numbers “0” through “10” are grouped by their remainder when divided by three (x % 3):

### Enumerable.Range(0, 10).Do(Console.WriteLine).GroupBy(x=>x % 3).Take(2).Select(g=>g.Take(2))

Upon iteration over the query results, “Console.WriteLine” will print numbers “0” through “9” (since the second parameter to Range indicates the number of values to produce). However, since the query only asked for two groups and the first two elements of each group, things can be done more efficiently. In fact, the result will be the following, where “{ . . . }” denotes syntax for sequences and “[k, { . . . }]” denotes syntax for groups with a given key “k,” followed by the group's elements:

{[0, {0, 3}], [1, {1, 4}]}

In other words, there are two groups “0” and “1,” where group “0” includes “0” and “3” and group “1” includes “1” and “4.”

As one can observe from the output, there is no need to iterate beyond the integer value “4” in the source sequence in order to provide the result of the query. In sum, the “GroupBy” operator as it is conventionally implemented is too eager, which also makes it unusable for infinite sequences and online processing of streams, among other things.

To resolve this issue, a lazy grouping operator can be employed, that has the same contract as the existing “GroupBy” operator. In particular, it maintains internal data structures to create groups lazily and only acquires elements from the source sequence when needed to respond to a request for a group or element. Further, lazy operation can be optimized by constraining creation and population of groups and/or elements, among other things. For instance, implementation of the lazy operator can be prohibited from creating more than two groups and more adding more than two elements per group as shown in the above example. More particularly, the lazy grouping operator could be restricted from producing a third group “2” with a single element “2” that would otherwise result from a lazy implementation.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

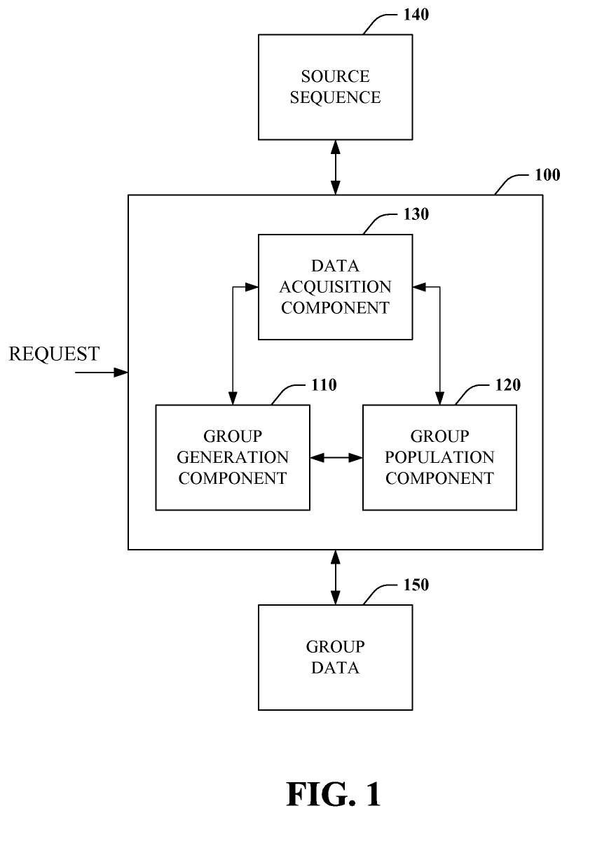

Referring initially to FIG. 1, a group processor system 100 is illustrated that enables lazy grouping. The group processor system 100 includes a group generation component 110, a group population component 120, and a data acquisition component 130. Furthermore, the group processor system 100 can receive requests, interact with a source sequence 140 (push- or pull-based data), and produce group data 150. In accordance with its lazy operation, the group processor system 100 does not perform any operation unless prompted by a request, for example for a group or element of a group. More specifically, group generation component 110 can respond to a request for a group, and group population component 120 can respond to a request for an element of a group.

The group generation component 110 is configured to generate groups dynamically or in other words as needed. Upon receipt of a request for a group, the group generation component 110 can iterate the source sequence 140 by way of data acquisition component 130, which can receive or retrieve elements from source sequence 140. If no prior groups were generated at the time of the request, the data acquisition component 130 likely need only return a single element. The group generation component 110 can then create a group for a key of the returned element, wherein the key is computed as a function of the element, for instance, and add the element to the newly created group. If, however, at least one group was previously created at the time of the request then the group generation component 110 can instruct the data acquisition component 130 to continue to iterate the source sequence 140 until an element with a previously unobserved key is identified. At this point, a new group can be generated and the element with the previously unobserved key added thereto.

The group population component 120 is configured to populate a group with elements as needed. Upon request for an element of a group that is not already part of the group, the group population component 120 can request that the data acquisition component 130 iterate the source sequence 140 until an element of the group is located. At this point, the located element can be added to the group and made available for consumption by a requesting entity.

The group generation component 110 and group population component 120 can interact with each other when performing their respective functions. For example, when the source sequence 140 is iterated by the data acquisition component 130 under the direction of the group generation component 110, intermediate elements (elements that are observed prior to observing an element of interest) may be identified that belong to a pre-existing group. Rather than discarding these elements, group generation component 110 can pass the element to the group population component 120 to be added to a pre-existing or previously generated group. Similarly, while the data acquisition component 130 is iterating the source sequence 140 under the direction of the group population component 120, intermediate elements may be identified that do not belong to a previously generated group. Accordingly, the group population component 120 can solicit assistance from the group generation component, which can create a new group associated with the element and add the element thereto. Note also that the group population component 120 can observe intermediate elements that belong to other groups besides a select group subject to a request. Accordingly, the group population component 120 can also add these intermediate elements to their respective groups. Overall, regardless of the reason for iteration of the source sequence 140 acquired elements can be added to an appropriate group so as not to lose any data and essentially pre-fetch elements for subsequent utilization.

The group data 150 stores groups and elements of groups that result from requests for such data. For example, group data 150 can be stored in an in-memory dictionary structure indexed by keys. Subsequently or concurrently, the group data 150 can be made available for retrieval, consumption, or the like by another system or component, for example.

In accordance with one aspect of the disclosure, the group processor system 100 can be thread safe. The group processor system 100 can be triggered from different places, which could all run on different threads. To make the group processor system 100 safe groups can be read, but not written to simultaneously.

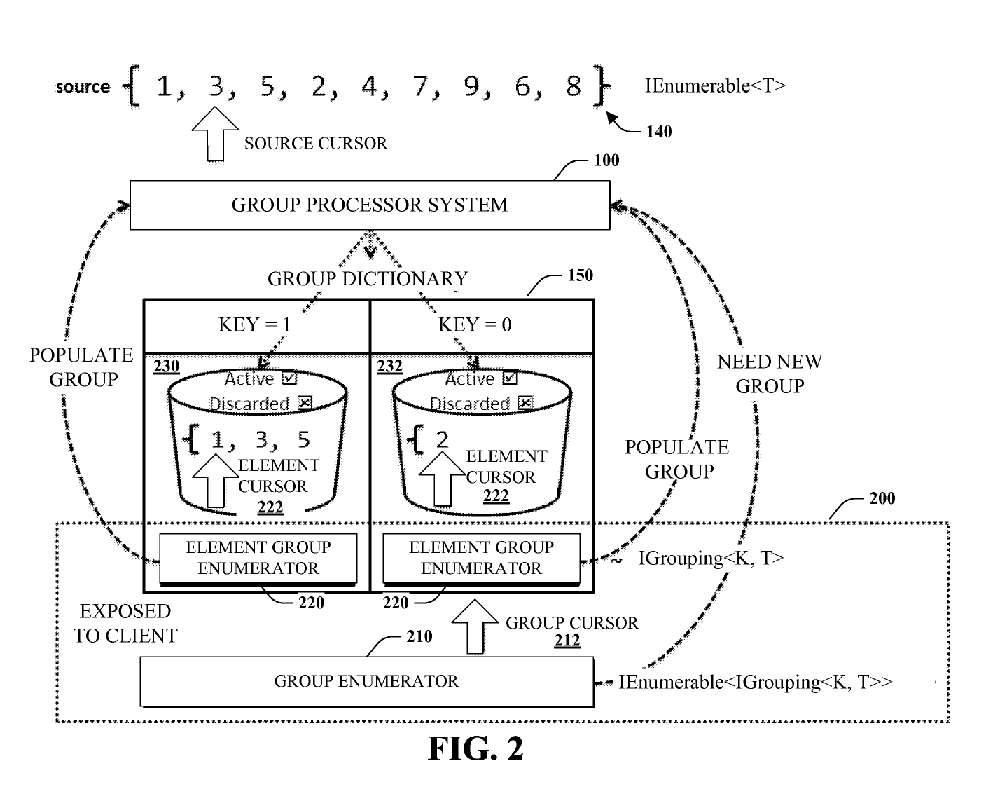

FIG. 2 illustrates employment of the group processor system 100 in an exemplary scenario to aid clarity and understanding. As shown, the group processor system 100, source sequence 140, and group data 150 are provided. Further provided are consumers 200 of group data 150, namely group enumerator component 210 and element group enumerator components 220. Here, the grouping query can group elements based on their “odd” or “even” characteristic.

The source sequence 140 is shadowed through the group processor system 100, which owns and maintains the group data 150, here a group dictionary. The group processor system 100 processes input upon being triggered by another component as will be described further below. Upon retrieval of an element from the source sequence 140, the group processor system 100 can check for an existing group. If one exists, the element is added to the group and the cursor is maintained as is. If no group exists yet, a new group can be created, the element can be added thereto, and the element cursor for the group can be set to zero.

Two consumers 200 or more specifically here two enumerators can be exposed to a client to acquire data. The group enumerator component 210 can maintain a cursor indicating the last group that was yielded to the consumer. Upon enumeration or iteration, beyond this point, the group enumerator component 210 requests that the group processor system 100 create a new group. The request can cause the group processor system 100 to run until the end of the source sequence 140 is reached or until an element with a distinct grouping key is encountered. While doing so, the group processor system 100 can populate existing groups with observed intermediate elements.

The element enumerator components 220 surface lazy groups of elements outside the group data 150. They also maintain a cursor keeping track of the next element to be yielded to a client enumerating or iterating over the group. If the cursor moves beyond the current group size, the group processor system 100 can be called again to scan for the next element belonging to the group or the end of the source sequence, whichever comes first. As will be discussed further with respect to optimization, in accordance with one aspect of the disclosure the elements that come before the current element cursor can be discarded to preserve space. This can be particularly important if groups are only iterated once, for example in an online processing system where a potentially infinite number of elements are supplied. In such a case, there may be no need to maintain yielded elements.

In operation, to acquire the first group 230 with a key of “1” corresponding to an odd number the number “1” needs to be observed. To acquire the second group 232 with a key of “0” corresponding to an even number, “3” and “5” are observed and added to the first group 230 before observing “2.” The acquisition of two groups has resulted in iteration over elements belonging to an already created group, namely the first group 230. Accordingly, the source sequence 140 need not be iterated as long as the elements desired are already grouped. For example, one can iterate through the first group 230 three times without requiring further interaction with the source sequence 140. However, if one desires a fourth element the source sequence 140 needs to be consulted, which will result in reads of “4” and “7.” In other words, to find “7,” which belongs to the first group 230, “4” was first observed and added to the second group 232. Of course, if the second group did not exist, the observation of “4” could give rise to the creation of the second group 232.

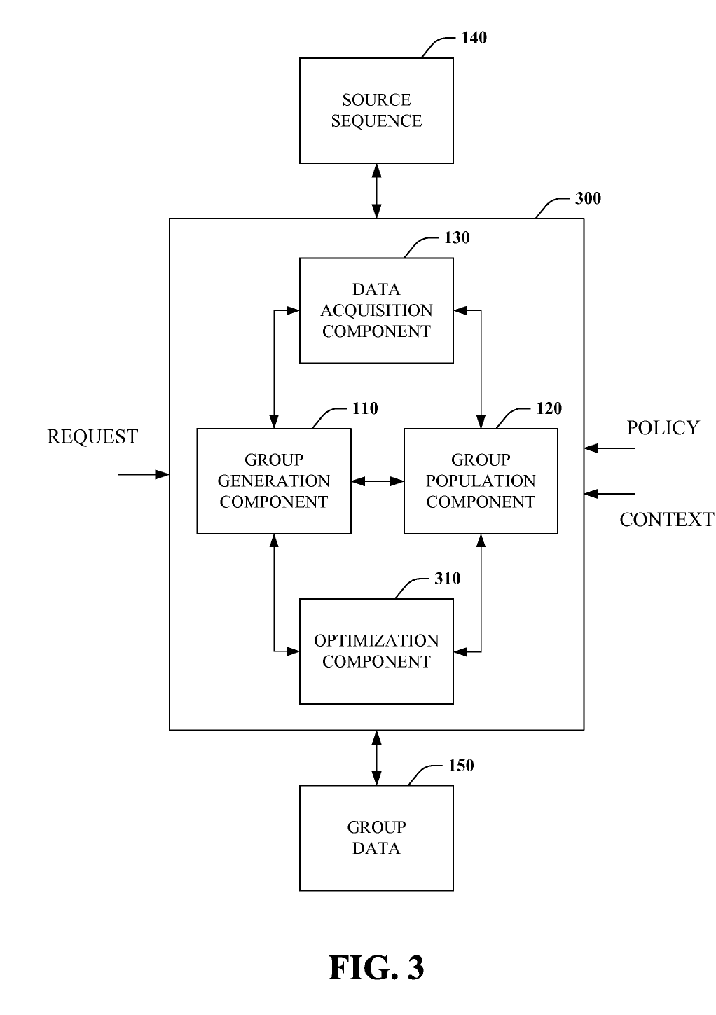

Turning attention to FIG. 3, an optimized group processor system 300 is depicted. Similar to the group processor system 100 of FIG. 1, the optimized group processor system 300 includes the group generation component 110, the group population component 120, the data acquisition component 130, which can interact with the source sequence 140, and group data 150. Furthermore, an optimization component 310 is included. The optimization component 310 is configured to optimize the use of computational power and space in implementing functionality of lazy operators such as “GroupBy.” Here, the optimization component 310 is communicatively coupled to the group generation component 110 and the group population component 120 to enable functionality provided thereby to optimized, controlled, or otherwise influenced by the optimization component 310. Additionally, the optimization component 310 can interact with the group data 150, for example to remove data to conserve space, for example in memory. Furthermore, the group generation component 110, the group population component 120, and the group data 150 can be configured to support interaction by the optimization component 310.

The optimization component 310 can receive, retrieve, or otherwise obtain or acquire configurable policies that dictate the functionality of the optimization component 310 as well as context information. For example, policy information can be passed in using one or more behavior flags on a “GroupBy” operator. In one instance, policies can indicate that the operations of the group generation component 110 and/or the group population component should be constrained based on context information associated with a query. By way of example and not limitation, a “GroupBy” operator can be followed by a “Take(n)” operator, which indicates that the first “n” groups and/or the first “n” elements of a group are of interest. Stated differently, operators such as “Take(n)” can applied to a sequence of produced groups (limiting the number of produced groups) or the individual groups themselves (limiting the number of elements returned). As a result, the optimization component 310 implements a policy that says only produce “n” groups and/or “n” elements per group. To implement this policy, the optimization component 310 can limit either or both of the group generation component 110 or group population component to producing solely “n” groups or “n” elements of a group. Additionally or alternatively, observers or other programmatic constructs that are interested in the group data 150 and that are driving production thereof can be terminated or otherwise disposed of after “n” groups and/or “n” elements are yielded to constrain lazy group generation and population.

Policies can also pertain to space reclamation after groups or elements are produced. For example, after elements are yielded they can either be maintained or discarded. In one instance, if groups of elements are only enumerated once and a large number (e.g., infinite number in online processing system) of elements are expected, then elements can be discarded after they are yielded to conserve space (e.g., buffer, memory . . . ). Similar policies can also be applied to groups. For example, if a group has not been iterated over and there is object or the like to iterate or otherwise observe a group, then the group can be discarded. In one implementation, groups can have state bits that can provide context information of interest such as whether a group has been iterated by a programmatic construct (e.g., active?) and can be used to indicate to another process to remove the group (e.g., discard?).

To illustrate at least a portion of such behavior, consider the following exemplary client-code over the sample sequence in FIG. 2 (“1, 3, 5, 2, 4, 7, 9, 6, 8”):

```
var res = xs.Do(Console.WriteLine).GroupBy(x => x %
2).Take(2).Select(g => g.Take(2));
foreach (var g in res)
{
    Console.WriteLine(“x % 3 == ” + g.Key);
    foreach (var x in g)
        Console.WriteLine(“ ” + x);
}
```

The “Take(2)” call on the grouping sequence will obtain all groups since “x % 2” produces two groups (“0” and “1”), but notice this does not mean the groups need to be fully populated. Stated differently, both the sequence of groups as well as the individual group sequences are lazy. This above code can be executed as follows with respect to FIG. 2.

The outer “foreach” asks for the next group (the first group). Since a group cursor 212 has not yet been set, the group processor system 100 is called to establish a new group. The group processor system 100 scans through the source, finds “1,” computes the key (1% 2->1) and checks whether a group already exists for that key. Since it does not, a group with key “1” is created and the element “1” is added to it. The group enumerator component 210 can then provide an element group enumerator 220 that will yield an enumerable for the produced group, wherein an enumerator can be requested from a produced group object. Further, the group cursor can be advanced such that a subsequent “MoveNext” call will trigger creation of a new group. As depicted, the group cursor 212 can represent an enumerator while a rectangle around a bucket can represent a group that is enumerable (able to be iterated).

The inner “foreach,” which acts over a “Take(2)” can now iterates over elements of the first group 230 using the acquired element group enumerator 220 (assuming there is only one enumeration per group, which need not be the case). Here, the cursor can point at element “1,” which was already added to the group upon group creation. This element can be yielded to the consumer and the cursor can be advanced. The next call to “MoveNext” hits a cursor that is beyond the end of the element group. Accordingly, the group processor system 100 is called to obtain the next element for the group. Here, the group processor system 100 scans the source sequence and encounters “3,” and adds this element to the already existing group based on the key (3% 2->1). At this point, the “Take(2)” has seen two elements from the group and can dispose of the element group enumerator 220, for example, to restrict further population of the group. Further action can be the result of policy settings. For example, the first group 230 can be marked as discarded, causing it to be emptied and no longer populated, wherein subsequent calls to the element group enumerator will cause an exception. Alternatively, the group can be maintained “as-is” allowing further “GetEnumerator” calls to see the entire group that was yielded so far, and also allowing the cursor to advance beyond the end at which point the group can grow further. For instance, another client for the group may choose to do a “Take(3)” operation.

The outer “foreach” asks for the next group (the second group). Since the group cursor 212 has advanced beyond the end of the current group dictionary, the group processor system 100 can be invoked to produce a new group. Upon scanning, the element “5” can be located, which belongs to an existing group—the first group 230. Action at this point can depend on a policy. Either the element is appended to the first group 230 or the element is discarded because the group is marked as discarded at the point its enumerator was disposed. Upon further scanning, “2” is located, which causes a new group to be generated, second group 232, since the computed key value is distinct from any other keys in the group dictionary. The new group is created, the element “2” is added to the group, an element group enumerator 220 is provided that will yield an enumerable for the produced group, wherein an enumerator can be requested from a produced group object, and the group cursor 212 is advanced. Here, the element cursor 222 can represent an enumerator while the bucket that houses the elements can represent a group that is enumerable (able to be iterated). The inner “foreach” again restricts itself to seeing two elements by group by means of a “Take(2)” call, now iterates over the newly created group. As previously explained, the group processor system 100 is looped in to populate the group on an on-demand basis.

Another example emphasizes the interaction between the group processor system 100, the group enumerator component 210, and the element group enumerator components 220. In the code below, elements belonging to different groups or buckets are mixed up. While a first group is being populated, new groups can be created and populated already:

var xs=new[ ] {1, 2, 4, 3, 5, 6, 7, 9, 8};
Consider a “Take(2)” for groups and a “Take(2)” for elements again, for example using nested iteration, as previously described. This time while scanning for the first group's second element (‘3”), a new group of even numbers is being created (upon observing “2) and populated (with “2” upon creation, and “4” as an effect of iteration to “3”). When the second group is subsequently requested, it is already present, and even more so, it was fully populated with the elements of interest “2” and “4.”

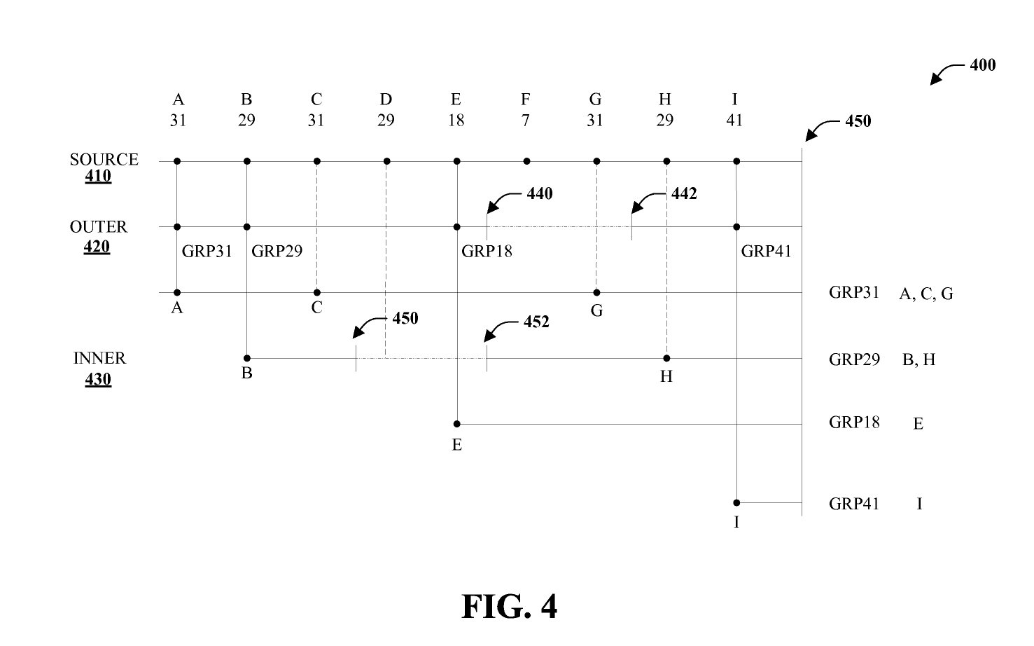

To further aid clarity and understanding with respect to the above aspects and to abstract way from some implementation details, consider the pseudo-marble diagram 400 of FIG. 4. As show, the diagram includes a source 410 corresponding to a source sequence of ages {31, 29, 31, 39, 18, 7, 31, 29, 41} that correspond to a set of respective people {A, B, C, D, E, F, G, H, I}. Outer 420 represents an outer group or, in other words, a group of groups of elements. Inner 430 corresponds to an inner group or, stated differently, a group of elements. Upon acquisition of element “A” with key “31,” a new group of elements is created “GRP31” and “A” is added to that group. Upon further scanning, for example, element “B” with key “29” can be revealed and cause a new group of elements to be created “GRP29” with element B. Subsequently, element “C” can be observed with a key “31.” Since a group of elements already exists for key “31,” “C” is added to that group. The process can continue similarly through acquisition of element “I” with key “41.”

At 440 directly following creation of “GRP18,” this point indicates that no further groups are to be created, which can correspond to a constraint or restriction on group creation. Subsequently, upon observation of element “F” with key “7,” a new group is not created even though it would otherwise have been created. Next, upon identification of element “G” with a key “31,” the element can be added to group “GRP31,” since it was previously created. Point 442 illustrates re-subscription to outer 420 or in other words allowing group creation once again. Accordingly, upon observation of element “I” with distinct key “41,” a new group can be created “GRP41” and element “I” added thereto.

At 450 directly following observation of “C,” group population can be constrained or restricted similar to the manner in which group creation was constrained at 440. Now, new elements are not permitted to be added to group “GRP29.” Accordingly, upon observation of element “D” with a key “29,” the element is simply ignored or discarded since no elements can be added to the corresponding group. At 452, the constraint is removed allowing the group to accept additional elements. Consequently, element “H” with key “29” can be added to the group “GRP29” upon iteration thereto.

At 460, the source 410 terminates. Consequently, all other groups including outer 420 and inner 430 are terminated as well. As shown, just prior to termination outer 420 includes four groups of groups of elements, namely “GRP31,” “GRP29,” “GRP18,” and “GRP41,” which respectively include elements “A, C, G,” “B, H,” “E,” and “I.”

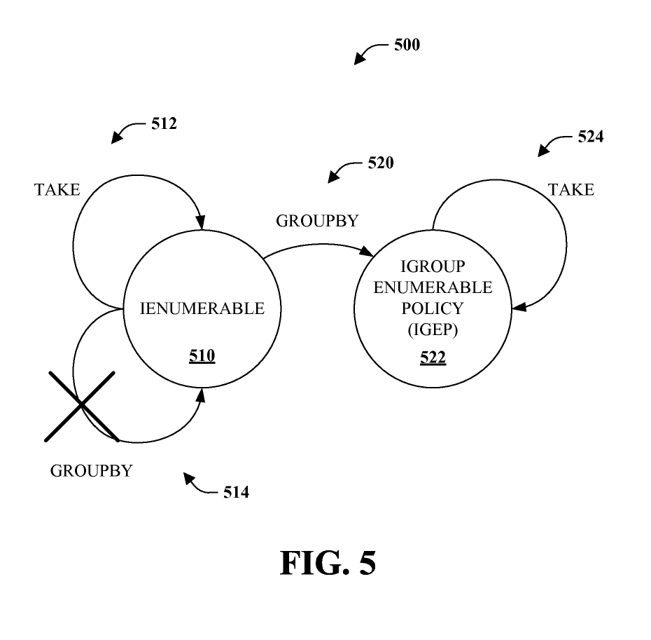

Turning to FIG. 5 a state machine diagram 500 is illustrated. In accordance with an embodiment of the claimed subject matter, specialized or new data types can be included for lazy operators such as “GroupBy” to provide context thereto to aid optimization, for example. In other words, policies can be expressed with respect to data types. “IEnumerable” 510 is an abstract data type that concerns collections of pull-based data. A source sequence can thus be of type “IEnumerable” 510. If one performs a “Take” operator/method on an “IEnumerable” 510 the result is another “IEnumerable” 510. Similarly, a “GroupBy” operator/method takes an “IEnumerable” 510 and returns an “IEnumerable” 510. This is problematic because no information can be gleaned about whether the “Take” operator/method 512 occurred before or after the “GroupBy” operator/method 514. To remedy this problem, a new type can be introduced such as “IGEP” (IGroupEnumerablePolicy) 512. Rather than a “GroupBy” operator/method 514 returning an “IEnumerable” 510, “GroupBy” operator/method 520 can operate over an “IEnumerable” 510 and return an “IGEP” 522. Furthermore, a specialized “Take” operator/method 524 can be defined over “IGEP” 522, which takes an “IGEP” 522 and returns an “IGEP” 522. In this manner, the difference between a “Take” that occurs before a “GroupBy” (“Take” applied to a sequence that is not an IGEP) and a “Take” that occurs after a “GroupBy” (“Take” applied to a sequence that is an IGEP) can be determined. Such information can be exploited to optimize the implementation of the “GroupBy,” for instance by constraining group creation and/or group population. By way of example and not limitation, a compiler can easily identify when a “GroupBy” is followed by a “Take” based on types and optimize the implementation of the “GroupBy” at compile time. Furthermore, the query and associated types can be utilized to generate a data representation of the query such as an expression tree that can be optimized at runtime based on the types.

It is to be appreciated that for purposes of brevity and simplicity, aspects of the disclosure have been described with respect to the “GroupBy” operator/method. However, such aspects are not limited thereto and in fact are easily extended various other operator/methods such as “SelectMany” and “OrderBy,” among others, in light of “Take,” “TakeWhile,” “TakeUntil,” and “Skip,” for instance.

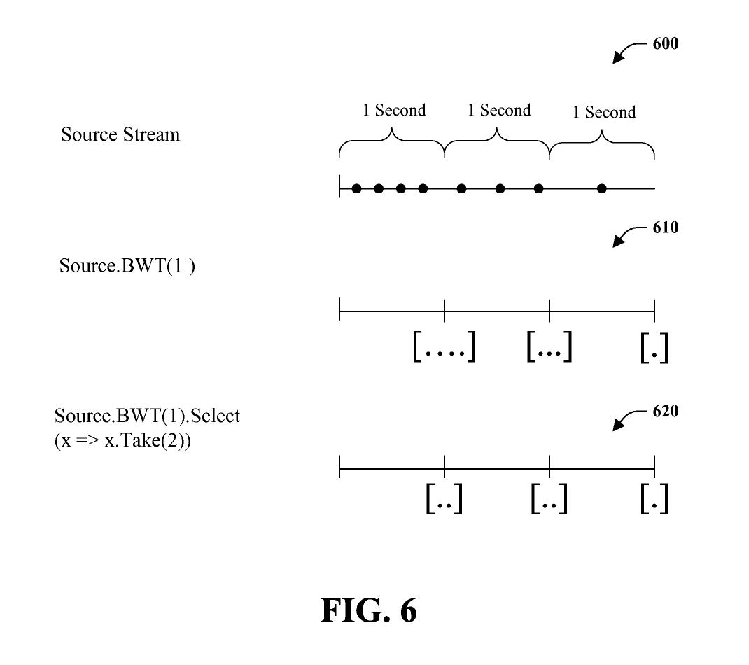

By way of example and not limitation, consider the “BufferWithTime” operator/method that divides a sequence into portions, or chunks, based on a time interval. As shown in FIG. 6, a source stream 600 can include a plurality of elements that are supplied at different times. The “BufferWithTime” operator/method 610 depicts accumulating or buffering of elements that are provided within intervals of one second. The “BufferWithTime” operator composed with a “Take” operator or method is shown at 620. In this case, the first two elements that occur within a one-second window are taken. Rather than taking in all elements that occur within a one-second time interval and subsequently discarding everything except the first two elements, this can be implemented much more efficiently by simply buffering the first two elements alone. In other words, the “BufferWithTime” operator/method can operate lazily and can be optimized utilizing context information regarding the composition with the “Take” operator/method.

Furthermore, while this detailed description has focused heavily on pull-based data (data actively pulled from a source) aspects of the disclosure are not limited thereto. In fact, disclosed aspects are equally applicable to push-based data (data that arrives at arbitrary times). For example, with respect to FIG. 5, IEnumerable 510 is specified as an abstract data type that concerns collections of pull-based data. However, disclosed aspects are equally applicable the abstract data type IObservable that deals with push-based data. Furthermore, a combination of push- and pull-based data can be utilized. For example, a source sequence can be push-based while grouped data can be pull-based.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the optimization component 310 can employ such mechanisms to determine or infer policies or modifications on operations that improve computation efficiency and/or space utilization.

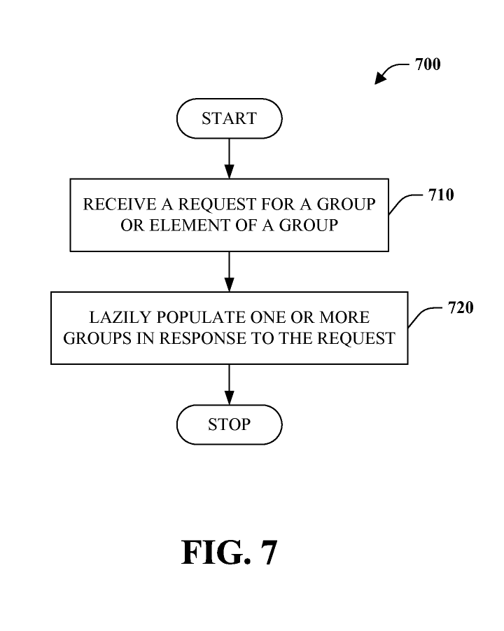

In view of the exemplary systems described supra, methodologies that may be implemented in accordance with the disclosed subject matter will be better appreciated with reference to the flow charts of FIGS. 7-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a method of lazy grouping 700 is illustrated. At reference numeral 710, a request for a group or element of a group is received, retrieved or otherwise obtained or acquired. At numeral 720, one or more groups are lazily populated in response to the request. In other words, rather than eagerly creating and populating groups, such functionality can be performed on-demand. For example, where a group does not yet exist one can be created and populated with an initial element from a source sequence, for instance. Similarly, if another element in a particular group is requested, the element can be located and added to the group. It should also be noted that while iterating a source sequence to locate an element for a new group that existing groups could be populated with intermediate elements. In addition, while seeking an element for a particular group other groups can be populated with intermediately located elements and new groups can be created. This interaction provides a sort of pre-fetching benefit while maintaining efficiency in acquiring a requested group or element of a group. Furthermore, such pre-fetching and caching is also helpful in avoiding multiple iterations over the same sequence, which could result in duplication of side effects associated with iteration or observation.

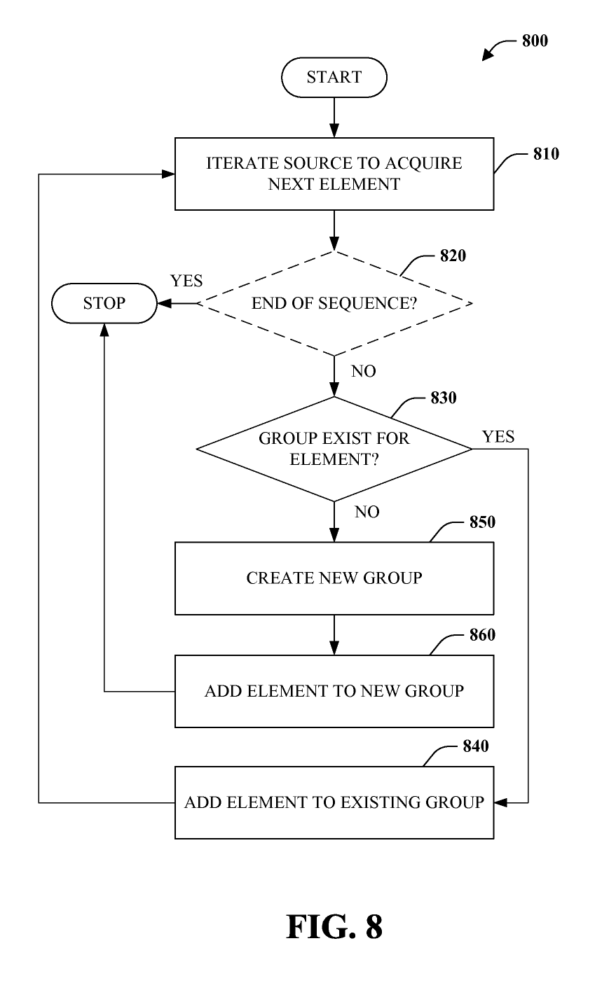

FIG. 8 illustrates a method of lazy group creation 800. At reference numeral 810, a source is iterated to acquire the next element in a sequence of elements upon request. At numeral 820, when dealing with finite sequences, a check can be made to determine whether the end of the sequence has been reached. In one implementation, this can be accomplished by analyzing the element retrieved. If the element is an end of sequence character or the like, then the end of the sequence has been reached (“YES”) and the method can be terminated. If not (“NO”), the method can continue at 830 where a determination is made as to whether a group exists for the acquired element. For instance, if a key associated with the element is present then a group already exists, whereas if the key is distinct from others acquired then the group does not exist. If a group does exists (“YES”), the method continues at 840 where the element is added to the existing group and subsequently a new element is acquired at reference numeral 810. If a group does not exist (“NO”), then a new group is created at 850 and the element is added to the new group at 860. Subsequently, the method can terminate since a new group has been created.

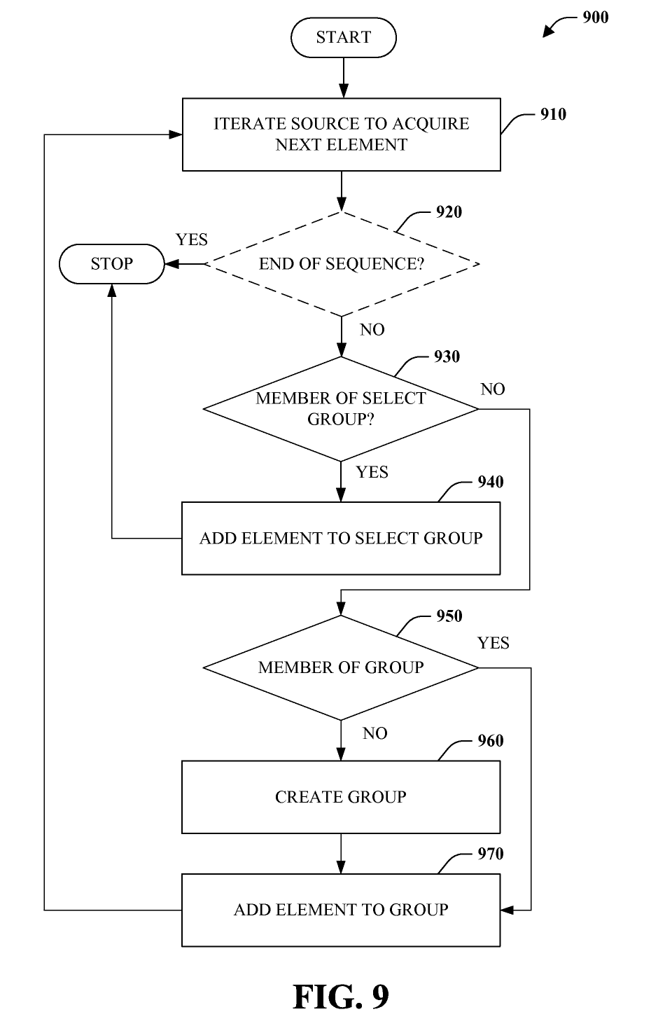

FIG. 9 depicts a method of lazily populating a group 900. At reference numeral 910, a sequence can be iterated to acquire the next element in a group as requested. At numeral 920, where the sequence is finite for example, a determination can be made regarding whether the end of the sequence has been reached, for instance as a function of the acquired element. If the end of the sequence has been reached (“YES”), the method terminates. Alternatively, if the end of the sequence has not been reached (“NO”), the method continues to numeral 939 where a determination is made concerning whether the acquired element is a member of a select group—that is, the group to be populated. If the element is a member of the select group (“YES”), the method continues at 940 where the element is added to the select group and the method terminates. If the element is not a member of the select group (“NO”), the method proceeds to 950 where a determination is made concerning whether the element is a member or any existing group. If the element is not a member of an existing group (“NO”), a group is created at 960 and the element is added to the newly created group at 970. If the element is a member of an existing group (“YES”), the element is added to that group at 970. Subsequently, the method continues at reference numeral 910 where the next element is acquired.

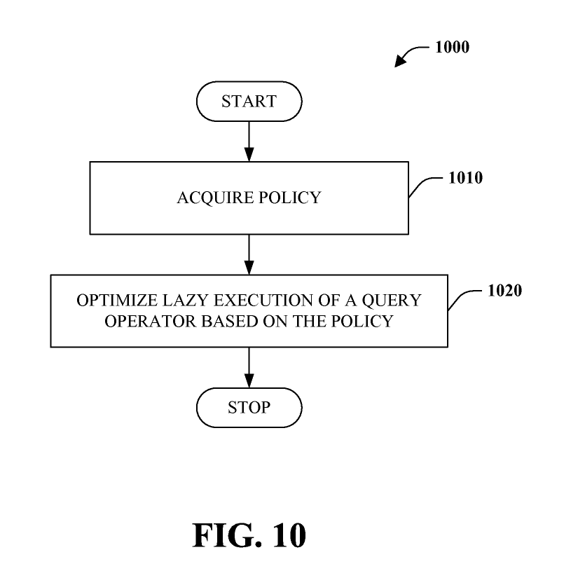

FIG. 10 is a flow chart diagram of a method of optimizing execution of lazy query operators 1000. At reference number 1010, a policy is acquired. A policy is like a rule in that it defines an action to be taken in a given context. For example, if a “GroupBy” operator is followed by a “Take” operator then the “GroupBy” operator implementation can be constrained such that some groups are not created and/or populated. In another instance, after elements are yielded to a consumer, for example, a policy can specify that they be deleted. Policies can be configurable to control the type and extent of optimization. At reference numeral 1020, lazy execution of a query operator is optimized based on one or more policies. Stated differently, a lazy implementation of a query operator can be optimized as a function of one or more policies.

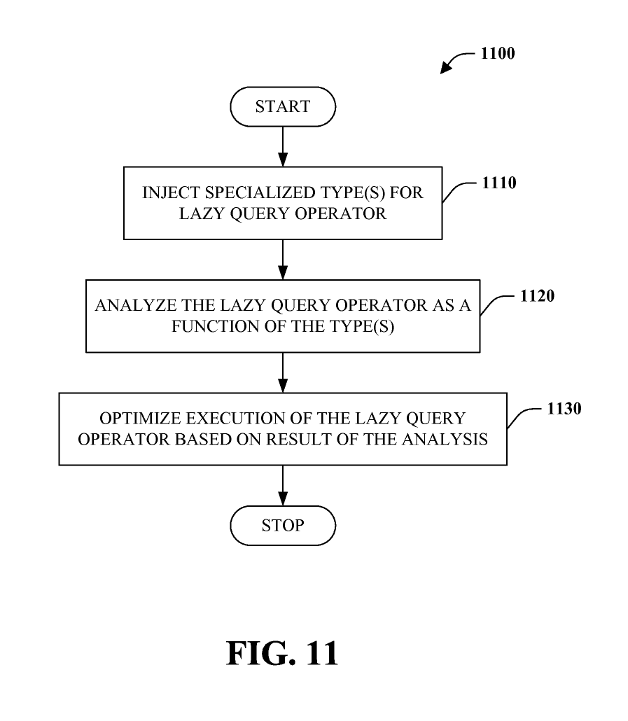

FIG. 11 is a flow chart diagram of a method of optimizing lazy execution of query operators with specialized types 1100. At reference numeral 1110, specialized or new data types for lazy query operators are injected to provide context that can aid in optimizing execution. For example, a new type can be added for the result of a “GroupBy” operator over which other operators can be defined. In other words, operators can be overloaded. At numeral 1120, a lazy query operator is analyzed as a function of query types. For example, it can be determined or inferred based on types that a “Take” operator followed a “GroupBy” operator. At reference numeral 1130, execution of the lazy query can be optimized based on the result of the analysis. For example, since the “Take” operator followed the “GroupBy” operator, the “GroupBy” operator can be constrained thereby. For example, the number of groups and/or elements can be restricted by a parameter of “Take,” such as “n” in “Take(n).” It should be appreciated that in accordance with one embodiment, a compiler can employ this method when generating code for implementing the “GroupBy” operator/method at compile time. Similarly, such context encoded in types can be utilized in generation of a data representation of the query such as an expression tree for remoting the query (transmitting the query across application boundaries), and as such optimization can occur at runtime.

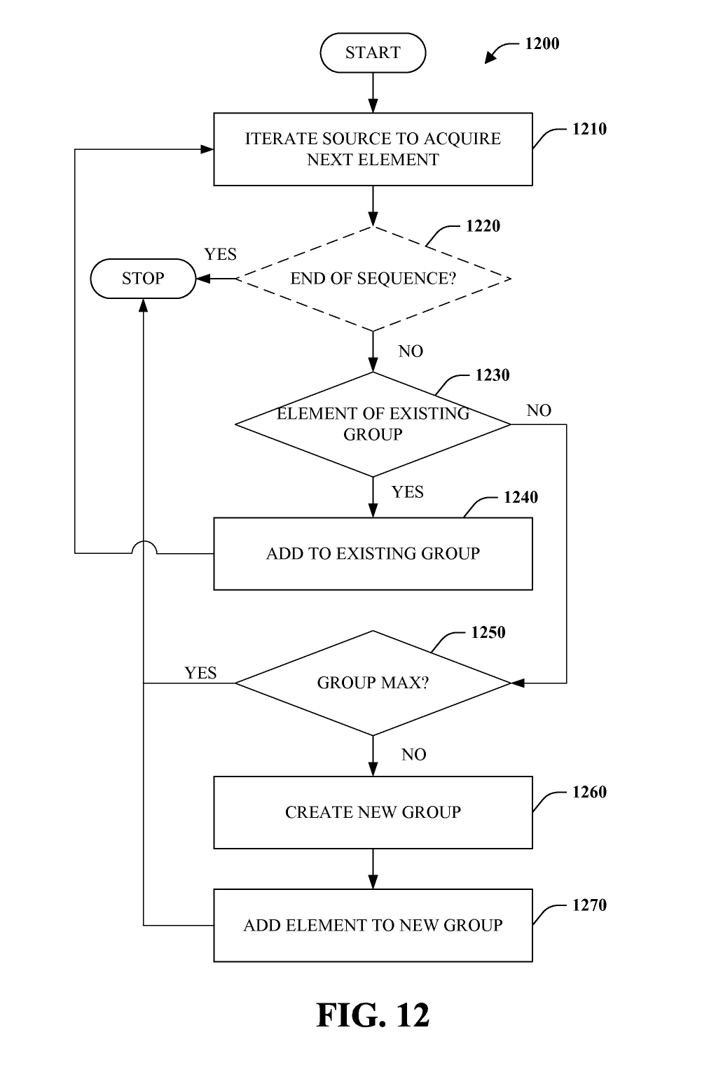

FIG. 12 illustrates a method of optimizing lazy creation of new groups 1200. At reference number 1210, a source is iterated to acquire the next element of a sequence in response to a request. At reference 1220, when a finite sequence is involved, a determination can be made as to whether the end of the sequence has been encountered. For example, the acquired element can be analyzed to determine if it corresponds to an end of sequence character. If, at 1220, it is determined that the end of a sequence has been encountered (“YES”), the method terminates. Otherwise (“NO”), the method proceeds at 1230 where a determination is made pertaining to whether the acquired element is a member of an existing group. If the element is a member of an existing group (“YES”), the element is added to the existing group at 1240, and a new element is acquired at 1210. Alternatively, if the element is not a member of an existing group (“NO”), the method continues at 1250 where a determination is made as to whether a maximum number of groups have been created already. If so (“YES”), the method terminates. If not (“NO”), the method continues at 1260 where a new group is created. At 1270, the element is added to the new group, and the method subsequently terminates.

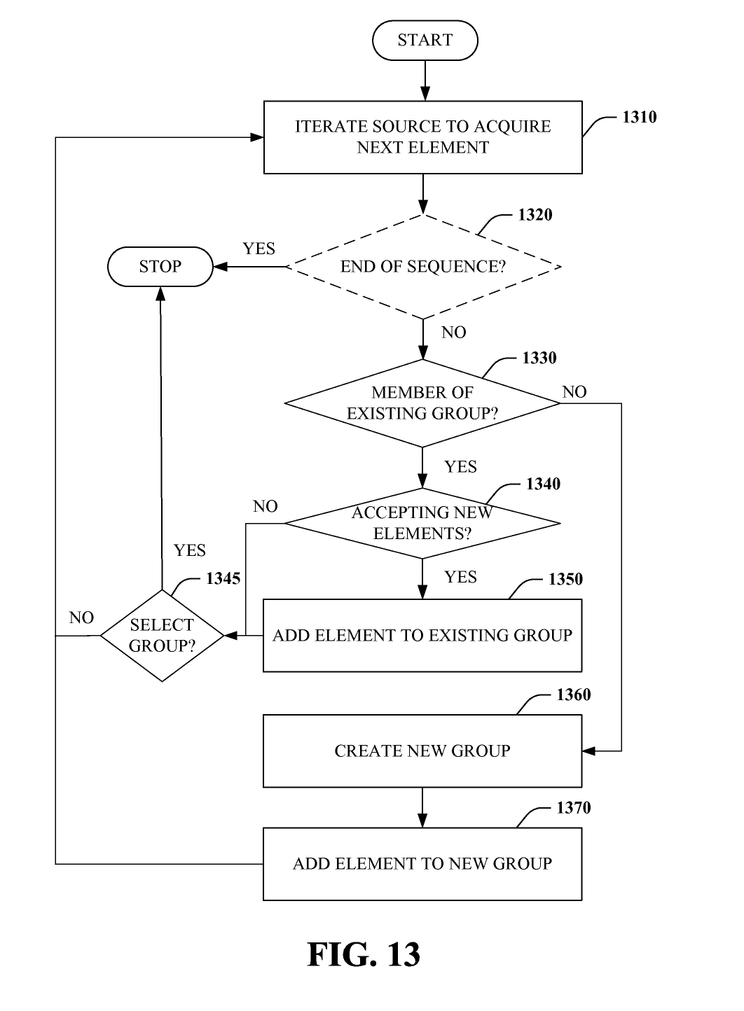

FIG. 13 depicts a method of optimizing lazy population of groups 1300. At reference numeral 1310, a source is iterated to acquire the next element of a sequence in response to a request to add an element to a select group. A check is made at 1320 as to whether the end of a sequence has been encountered. If the end of the sequence has been encountered (“YES”), the method terminates. Otherwise (“NO”), the method continues at 1330 where a determination is made as to whether the element is a member of a group. If it is a member of a group (“YES”), the method proceeds to 1340 where a determination is made as to whether the corresponding existing group (e.g., group with same key) is accepting new elements. If the group is not accepting new elements (“NO”), the method continues at 1345. If it is accepting new elements (“YES”), the method continues at 1350 where the element is added to the group and then to 1345. At 1345, a determination is made as to whether the corresponding existing group is the select group. If it is the select group (“YES”), the method terminates. Otherwise (“NO”), the method continues at 1310. If at 1330 it is determined that the element is not a member of an existing group (“NO”) then the method proceeds to 1360 where a new group is created and then to 1370 where the element is added to the new group. Next, the method loops back to 1310 and continues to loop until the end of the sequence is encountered or an element for a select group is found.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

As used herein, the verb forms of the word “remote” such as but not limited to “remoting,” “remoted,” and “remotes” are intended to refer to transmission of code or data across application domains that isolate software applications physically and/or logically so they do not affect each other. After remoting, the subject of the remoting (e.g., code or data) can reside on the same computer on which they originated or a different network connected computer, for example.

To the extent that the term “query expression” is used herein, it is intended to refer to a syntax for specifying a query, which includes one or more query operators that, in one implementation, map to underlying language primitive implementations such as methods that these names represent. Of course, “mapping” and/or a “language primitive” are not strictly required. Rather, any way a query can be represented to control its translation and/or execution in some manner will suffice.

As used herein, the term “sequence” is intended to refer broadly to a series of data. Accordingly, a sequence can refer to push-based data or pull-based data unless otherwise noted (e.g., push-based sequence, pull-based sequence). Similarly, terms such as “iterate” or forms thereof that may typically be associated with either push-based or pull-based data, unless otherwise noted, are intended to be equally applicable to both push- and pull-based data.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

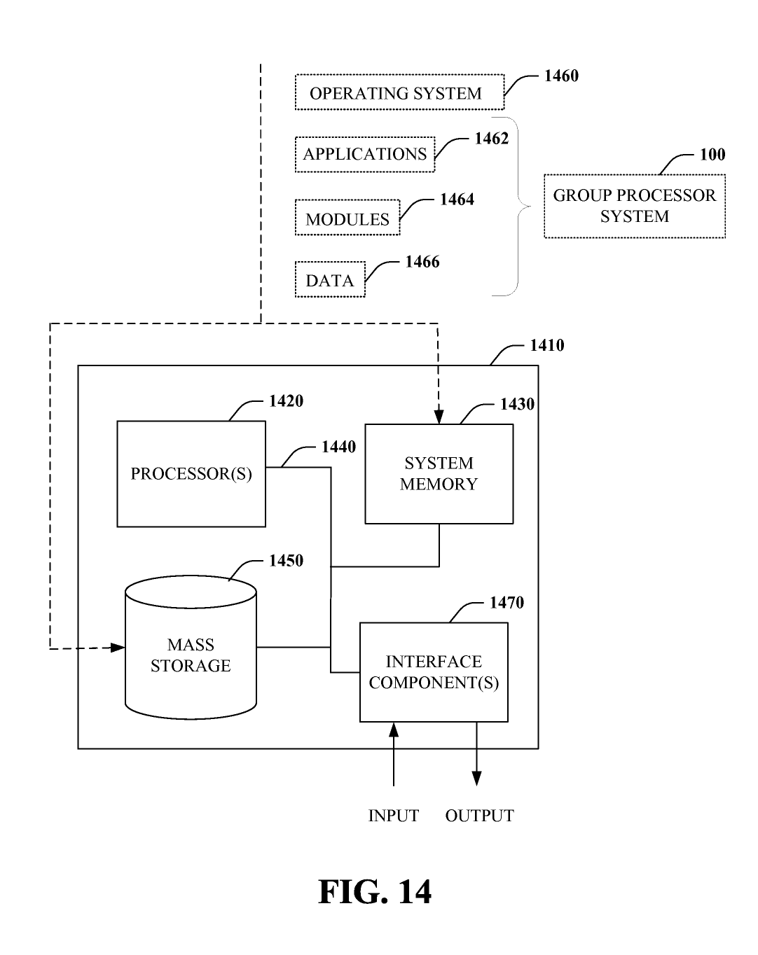

In order to provide a context for the claimed subject matter, FIG. 14 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 14, illustrated is an example computer 1410 or computing device (e.g., desktop, laptop, server, hand-held, programmable consumer or industrial electronics, set-top box, game system . . . ). The computer 1410 includes one or more processor(s) 1420, system memory 1430, system bus 1440, mass storage 1450, and one or more interface components 1470. The system bus 1440 communicatively couples at least the above system components. However, it is to be appreciated that in its simplest form the computer 1410 can include one or more processors 1420 coupled to system memory 1430 that execute various computer executable actions, instructions, and or components.

The processor(s) 1420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1420 may also be implemented as a combination of computing devices, for example a combination of a DSP and a microprocessor, a plurality of microprocessors, multi-core processors, one or more microprocessors in conjunction with a DSP core, or any other such configuration.

The computer 1410 can include or otherwise interact with a variety of computer-readable media to facilitate control of the computer 1410 to implement one or more aspects of the claimed subject matter. The computer-readable media can be any available media that can be accessed by the computer 1410 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1410.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1430 and mass storage 1450 are examples of computer-readable storage media. Depending on the exact configuration and type of computing device, system memory 1430 may be volatile (e.g., RAM), non-volatile (e.g., ROM, flash memory . . . ) or some combination of the two. By way of example, the basic input/output system (BIOS), including basic routines to transfer information between elements within the computer 1410, such as during start-up, can be stored in nonvolatile memory, while volatile memory can act as external cache memory to facilitate processing by the processor(s) 1420, among other things.

Mass storage 1450 includes removable/non-removable, volatile/non-volatile computer storage media for storage of large amounts of data relative to the system memory 1430. For example, mass storage 1450 includes, but is not limited to, one or more devices such as a magnetic or optical disk drive, floppy disk drive, flash memory, solid-state drive, or memory stick.

System memory 1430 and mass storage 1450 can include, or have stored therein, operating system 1460, one or more applications 1462, one or more program modules 1464, and data 1466. The operating system 1460 acts to control and allocate resources of the computer 1410. Applications 1462 include one or both of system and application software and can exploit management of resources by the operating system 1460 through program modules 1464 and data 1466 stored in system memory 1430 and/or mass storage 1450 to perform one or more actions. Accordingly, applications 1462 can turn a general-purpose computer 1410 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the group processor system 100 can be or form part of part of an application 1462, and include one or more modules 1464 and data 1466 stored in memory and/or mass storage 1450 whose functionality can be realized when executed by one or more processor(s) 1420, as shown.

The computer 1410 also includes one or more interface components 1470 that are communicatively coupled to the system bus 1440 and facilitate interaction with the computer 1410. By way of example, the interface component 1470 can be a port (e.g., serial, parallel, PCMCIA, USB, FireWire . . . ) or an interface card (e.g., sound, video . . . ) or the like. In one example implementation, the interface component 1470 can be embodied as a user input/output interface to enable a user to enter commands and information into the computer 1410 through one or more input devices (e.g., pointing device such as a mouse, trackball, stylus, touch pad, keyboard, microphone, joystick, game pad, satellite dish, scanner, camera, other computer . . . ). In another example implementation, the interface component 1470 can be embodied as an output peripheral interface to supply output to displays (e.g., CRT, LCD, plasma . . . ), speakers, printers, and/or other computers, among other things. Still further yet, the interface component 1470 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of query operator execution, comprising:
employing at least one processor configured to execute computer-executable instructions stored in memory to perform the following acts:
lazily populating one or more groups with one or more elements from a source sequence in response to a request for a group or element of a group.

2. The method of claim 1 further comprising lazily creating the one or more groups.

3. The method of claim 2 further comprising:
iterating over the source sequence in response to a request for a new group until an element with a previously unobserved key is identified;
adding the element to a newly created group; and
adding observed intermediate elements to existing groups.

4. The method of claim 2 further comprising limiting creation of the one or more groups to a bounded number of groups.

5. The method of claim 1 further comprising:
iterating over the source sequence in response to a request for an element of a group until the element is observed;
adding the element to the group; and
adding observed intermediate elements to an existing or newly created group.

6. The method of claim 1 further comprising limiting population of at least one of the one or more groups.

7. The method of claim 1 further comprising discarding yielded or observed elements.

8. The method of claim 1, further comprising identifying constraints on the act of lazily populating as a function of one or more data types associated with a query.

9. A system that facilitates execution of a group operation, comprising:
a processor coupled to a memory, the processor configured to execute the following computer-executable components stored in the memory:
a first component configured to create and populate groups lazily from a data source in response to a request for a group or element of a group.

10. The system of claim 9 further comprising a second component configured to request the group.

11. The system of claim 9 further comprising a second component configured to request the element of a group.

12. The system of claim 9 further comprising a second component configured to limit creation of groups.

13. The system of claim 9 further comprising a second component configured to limit population of a group.

14. The system of claim 9, further comprising a second component configured to discard yielded elements.

15. The system of claim 9, further comprising a second component configured to discard a group.

16. The system of claim 9 further comprises a second component configured to identify constraints on at least one of lazy creation or population of groups as a function of one or more data types.

17. A computer-readable medium having instructions stored thereon that enables at least one processor to perform the following acts:
analyzing one or more query operators comprising a query as a function of data types; and
optimizing lazy execution of a query operator at compile-time based at least in part on results of the analyzing act.

18. The computer-readable medium of claim 17, optimizing lazy execution comprises limiting creation of groups.

19. The computer-readable medium of claim 17, optimizing lazy execution comprises limiting population of a group with elements.

20. The computer-readable medium of claim 17, optimizing lazy execution comprises discarding elements yielded in response to a request.
